(19) United States
(12) Patent Application Publication
(10) Pub. No.: US 2026/0061418 A1
(43) Pub. Date: Mar. 5, 2026

(54) NANOCHANNEL FUNNEL STRUCTURES AND FABRICATION METHODS

(71) Applicant: Robert Bosch GmbH, Stuttgart (DE)

(72) Inventors: Christopher JOHNSON, San Carlos, CA (US); Nicole HINTZ, Sunnyvale, CA (US); Gabrielle VUKASIN, San Jose, CA (US); Martina HUEBNER, Renningen (DE)

(21) Appl. No.: 18/829,006

(22) Filed: Sep. 9, 2024

Related U.S. Application Data
(60) Provisional application No. 63/689,628, filed on Aug. 30, 2024.

(51) Int. Cl. B01L 3/00; B82Y 40/00

(52) U.S. Cl. CPC B01L 3/502707; B01L 2300/0896; B82Y 40/00

(57) ABSTRACT

A method of fabricating a nanochannel including a funnel-like inlet structure is provided. The method includes providing a wafer including a substrate, a first layer deposited on the substrate, a stop layer deposited on the first layer, a sacrificial layer deposited on the stop layer, and a structuring layer deposited on the sacrificial layer. The stop layer, the sacrificial layer, and the structuring layer forming a layer stack defining a nanochannel etch. The method may additionally include forming an underetch and depositing a capping layer on the structural layer to seal the nanochannel. A protecting layer may be deposited on the capping layer to protect the availability of an etchant molecule. A microchannel etch may be formed in the layer stack adjacent to the nanochannel etch, and the sacrificial layer next to an opening of the nanochannel may be etched to form a funnel-like inlet structure.

### CROSS-REFERENCE TO RELATED APPLICATIONS

This application claims the benefit of U.S. provisional application Ser. No. 63/689,628 filed Aug. 30, 2024, the disclosure of which is hereby incorporated in its entirety by reference herein.

### TECHNICAL FIELD

The present disclosure relates to methods for fabricating nanochannels and nanochannel structures (e.g., inlet structures).

### BACKGROUND

Nanochannels may be used as a part of an analytic device for biomolecules including but not limited to DNA, RNA, proteins, or other polymeric molecules. Nanochannels with inlet structures may be fabricated using e-beam lithography or fusion ion beam milling. These methods are cost intensive and time consuming and are not scalable. As such, there is a need for methods for fabricating nanochannels that address one or more of these issues.

### SUMMARY

In at least an aspect, a method of fabricating a nanochannel including a funnel-like inlet structure is provided. The method may comprise providing a wafer including a substrate, a first layer deposited on the substrate, a stop layer deposited on the first layer, a sacrificial layer deposited on the stop layer, a structuring layer on the sacrificial layer, and the stop layer, the sacrificial layer, and the structuring layer comprising a layer stack defining a nanochannel etch. The method may also include applying an isotropic etchant to attack an open edge of the sacrificial layer without etching the stop or structuring layers to form an underetch; depositing a capping layer on the structural layer to seal the nanochannel; depositing a protecting layer on the capping layer to protect an availability of an etchant molecule; forming a microchannel etch in the layer stack adjacent to the nanochannel etch; and applying an isotropic etchant to selectively etch the sacrificial layer and capping layer next to an opening of the nanochannel to form a funnel-like inlet structure.

In at least another aspect, a method of fabricating an analytic device for biomolecules is provided. The method may comprise providing a layer stack including a silicon wafer, a first layer deposited on the silicon wafer, a sacrificial layer deposited on the first layer, and a structuring layer on the sacrificial layer. The method may also include forming a nanochannel by etching the layer stack to form a nanochannel etch, etching the sacrificial layer to form an underetch, depositing a capping layer on the structural layer to seal the nanochannel, and depositing a protecting layer on the capping layer to protect an availability of an etchant molecule. The method may also include forming a microchannel etch in the layer stack adjacent to the nanochannel etch; and applying an isotropic etchant to selectively etch the sacrificial layer next to an opening of the nanochannel to form a funnel-like inlet structure.

In yet another aspect, a method of fabricating an inlet structure in front of a nanochannel is provided. The method may comprise providing a wafer including a substrate, a first layer deposited on the substrate, a stop layer deposited on the first layer, a sacrificial layer deposited on the stop layer, a structural layer on the stop layer, and the stop layer, the sacrificial layer, and the structuring layer comprising a layer stack defining a nanochannel etch; depositing a capping layer on the structural layer to seal the nanochannel; depositing a protecting layer on the capping layer to protect an availability of an etchant molecule; forming a microchannel etch in the layer stack adjacent to the nanochannel etch; and applying an isotropic etchant to selectively etch the sacrificial layer next to an opening of the nanochannel to form a funnel-like inlet structure.

### BRIEF DESCRIPTION OF THE DRAWINGS

FIG. 1 illustrates a cross section view of a wafer.

FIG. 2 illustrates a cross section view of a layer stack.

FIG. 3 illustrates a cross section view of a nanochannel etch in the layer stack.

FIG. 4 illustrates a cross section view of an underetch in the layer stack.

FIG. 5A illustrates a cross section view of a second capping layer on the layer stack.

FIG. 5B illustrates a view rotated 90° with respect to the cross section view in FIG. 5A.

FIG. 6A illustrates a cross section view of a microchannel etch in the layer stack.

FIG. 6B illustrates a view rotated 90° with respect to the cross section view in FIG. 6A.

FIG. 6C illustrates a top view of a microchannel etch in the layer stack.

FIG. 7 illustrates a top view of a funnel-etch in the layer stack according to an embodiment.

FIG. 8A illustrates a microscope image of a layer stack prior to the funnel etch step.

FIG. 8B illustrates a microscope image of a layer stack after the funnel etch step.

FIG. 9 illustrates a layer stack with funnel etches.

FIGS. 10A through 10C illustrate the effects of varying etching parameters on the width and depth of the funnel etch.

FIG. 11 illustrates a method for fabricating a nanochannel with a funnel-like inlet structure in front of the nanochannel according to an embodiment.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about”. The first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

Unless indicated otherwise, all technical and scientific terms used herein have the same meaning as commonly understood by one of ordinary skill in the art to which the present disclosure belongs.

It is also to be understood that this disclosure is not limited to the specific embodiments and methods described below, as specific components and/or conditions may, of course, vary. Furthermore, the terminology used herein is used only for describing particular embodiments and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The terms “or” and “and” can be used interchangeably and can be understood to mean “and/or”.

The term “comprising” is synonymous with “including,” “having,” “containing,” or “characterized by. ” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. When one of these three terms is used, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g., pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

Nanochannels can be used as one part of an analytic device for biomolecules including but not limited to DNA, RNA, proteins, or other polymeric molecules. Nanochannels may be characterized by a width and a height in the nanometer (nm) range. The term depth relates to how far the funnel etch process permeates within the nanochannel and can be from nanometer (nm) to micrometers (μm). The length is much greater than the width and may be in the range of micrometers (μm) up to millimeters (mm). A nanochannel may be used to pull a biomolecule through for further analysis. Due to the small size of the nanochannel, the biomolecule may be linearized in the channel which facilitates the analyses. Interfacing microfluidic structures may bring the molecules to the nanochannels.

An inlet structure in front of a nanochannel, including a funnel or gradient inlet, may provide an advantage for analysis systems over nanochannels with abrupt openings. A nanochannel with an inlet structure in front of it may reduce the rate of movement of biomolecules, through the channel. It may also stretch biomolecules, avoid the clogging of nanochannels, lead to higher capture rates, and decrease the necessary electrical field for bringing a biomolecule such as DNA into a channel. There is an entropic barrier that polymeric biomolecules including DNA must overcome to enter a nanochannel. This barrier is higher at an abrupt opening as the transition to confinement is extreme. With a funnel structure the gradual transition from a micro to a nano environment may reduce the barrier to entry.

Nanochannels with inlet structures have been fabricated using e-beam lithography or Focused Ion Beam (FIB) milling. These methods, however, may be cost intensive and time consuming, and are not considered scalable. Therefore, a funnel-like inlet structure in front of the nanochannel created by scalable micro-electromechanical systems (MEMS) processes may be advantageous. A method for fabricating a nanochannel with a funnel-like inlet structure in front of the nanochannel is therefore provided herein in one or more embodiments.

In one or more embodiments, the funnel-like inlet structure may be achieved by adding an etch step after fabrication of the nanochannel and of an adjacent microchannel. This etch step may be performed using the same etch mechanism as the under etching for the fabrication of the nanochannels earlier in the process. This etching step after fabrication of micro- and nanochannels may widen the small nanochannel opening towards the microchannel. The etching step may be faster at the entrance of the channel than at the inside, which may lead to a horizontal funnel inlet. An additional advantage of the method in one or more embodiments is that no photolithography or alignment step is necessary to create the funnels.

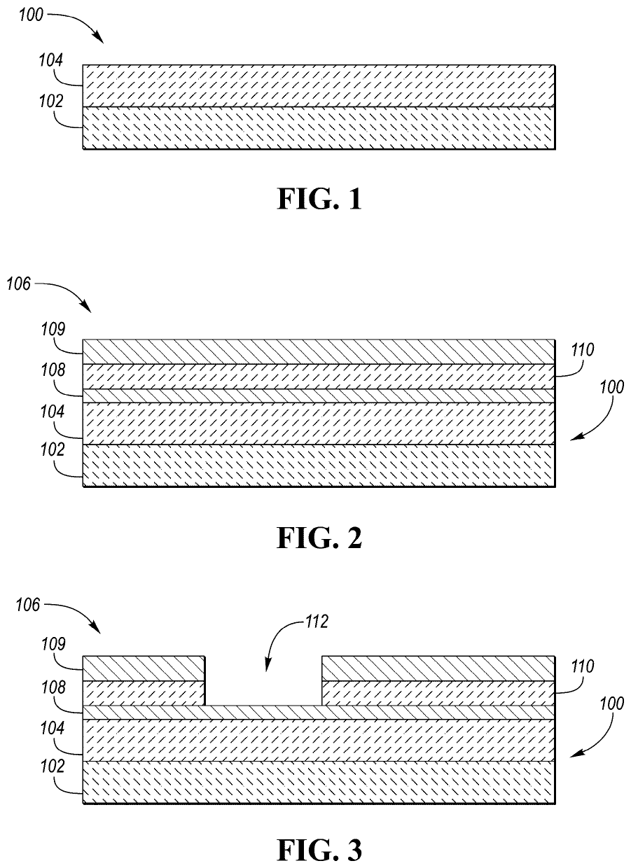

FIGS. 1-7 illustrate a wafer and layer stack including a nanochannel with a funnel-like inlet structure in front of it fabricated via a method for fabricating a nanochannel with a funnel-like inlet structure outlined in FIG. 8. Fabrication of the nanochannels as illustrated in FIGS. 1-6 are described in more detail in DE 102024203436.3.

FIG. 1 illustrates a cross section view of a wafer 100. As shown in FIG. 1, the wafer 100 includes a substrate 102. The substrate 102 may be formed of a silicon material. A first layer 104 may be deposited on the substrate 102. The first layer 104 may be SiO₂. The first layer 104 may be deposited on the substrate 102 via thermal oxidation for example. In certain embodiments, the wafer 100 may include passivation layers and/or metal (electrode) layers.

FIG. 2 illustrates a cross section view of a layer stack 106. The layer stack 106 may include the wafer 100 having the substrate 102 and the first layer 104. The layer stack 106 may also include a second layer 108 deposited on the first layer. The second layer 108 may be aluminum oxide (AlOx). The second layer 108 may also be referred to as a stop layer 108. The stop layer may be deposited via atomic layer deposition, plasma enhanced chemical vapor deposition, sputtering, or similar deposition methods. The layer stack may additionally include a sacrificial layer 110 deposited on the stop layer. The sacrificial layer 110 may be SiN for example. The sacrificial layer 110 is a different material than that of the stop layer 108. The sacrificial layer 110 may be deposited by atomic layer deposition (ALD) for example. The layer stack 106 may also include a structuring layer 109 deposited on the sacrificial layer. The structuring layer 109 may be AlOx. The structuring layer 109 is a different material than that of the sacrificial layer 110. The structuring layer 109 may be the same material as that of the stop layer 108. Alternatively, the structuring layer 109 may be a different material from that of the stop layer 108. Both the stop layer 108 and the structuring layer 109 are of a material that is not etched in the etchant that etches the sacrificial layer 110. For example, AlOx or SiOx do not etch in XeF₂. Other dielectric materials that do not etch in XeF₂ may also be used for the stop layer 108 or the structuring layer 109.

FIG. 3 illustrates a cross section view of a nanochannel etch 112 in the layer stack 106. The nanochannel etch 112 may be formed by structuring the structuring layer 109, the sacrificial layer 110, and the stop layer 108 with a lithography process, for example, and by etching via dry etching techniques. For example, the structuring layer 109, the sacrificial layer 110, and the stop layer 108 may be etched via ion beam etching or reactive ion etching. Through this step an open edge of the structuring layer 109, the sacrificial layer 110, and the stop layer 108 may be created. With this step, the etching proceeds down into the layer stack 106, through the structuring layer 109 and the sacrificial layer 110, but is stopped when it reaches the stop layer 108. The first layer 104 is not etched by this process. The first layer 104 is a material that is not etched by this etching process. The nanochannel etch 112 may form a nanochannel of 10 to 1000 nm in width by 5 to 1000 nm in height. Alternatively, the nanochannel formed by the nanochannel etch 112 may be 20 to 800 nm wide by 10 to 50 nm high, or 50 nm wide by 20 nm high.

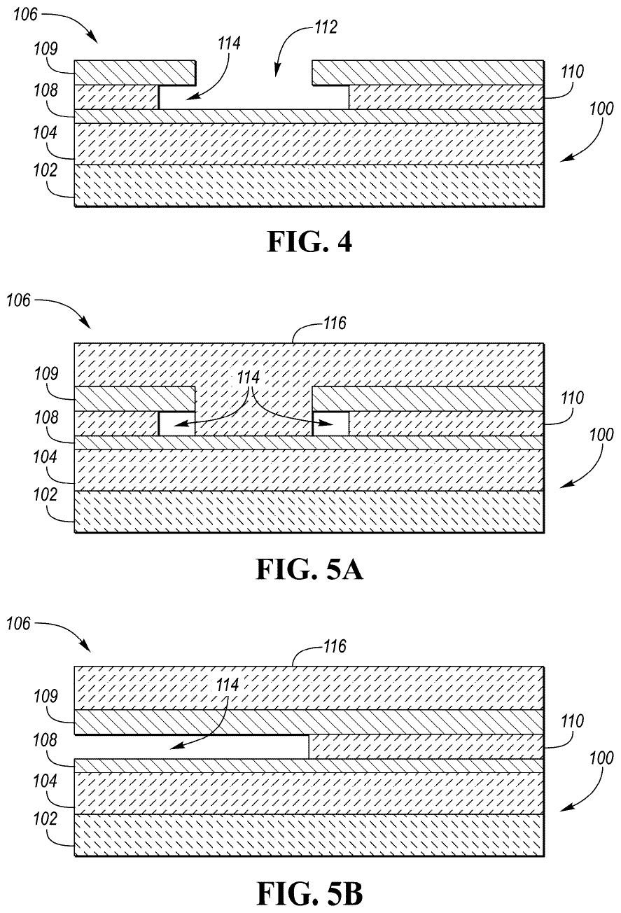

FIG. 4 illustrates a cross section view of an underetch 114 in the layer stack 106. The open edge created by the structuring and etching of the structuring layer 109, the sacrificial layer 110, and the stop layer 108 may allow an isotropic etchant to attack the open edges of the sacrificial layer 110. The etchant used does not attack the structuring layer 109 or the stop layer 108. In this way, an underetch 114 may be formed.

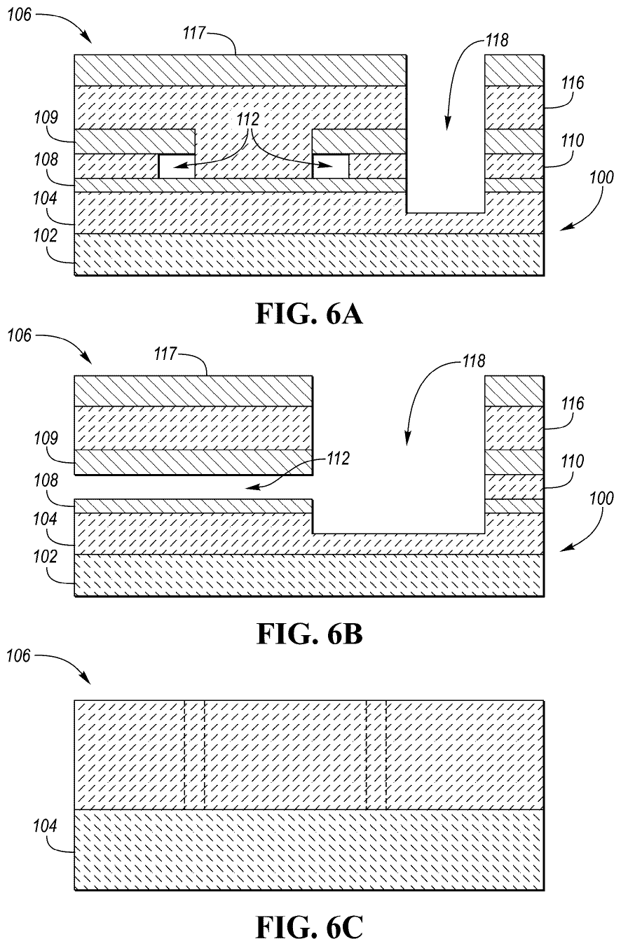

FIGS. 5A and 5B illustrate a cross section view (5A) and a view rotated 90° (5B) with respect to the cross section view of a capping layer 116 on the layer stack 106. The capping layer 116 may be deposited on the structuring layer 109 and on the stop layer 108. The capping layer 116 may be deposited on the stop layer 108 in the area of the nanochannel etch 112 but may not be deposited in the area of the underetch 114. In this way, the capping layer 116 may cap or seal the nanochannel. The capping layer 116 may be deposited by methods including plasma enhanced chemical vapor deposition, sputtering, or evaporation for example. The capping layer 116 may be SiN. In alternate embodiments the capping layer 116 may be SiO₂ for example. The material of the capping layer 116 may be selected based on considerations of later etching steps and also of the stress state of the wafer 100. The deposition of the capping layer 116 caps or seals the nanochannel formed by the nanochannel etch 112 prior to initiating the microchannel etching step described in FIGS. 6A through 6C.

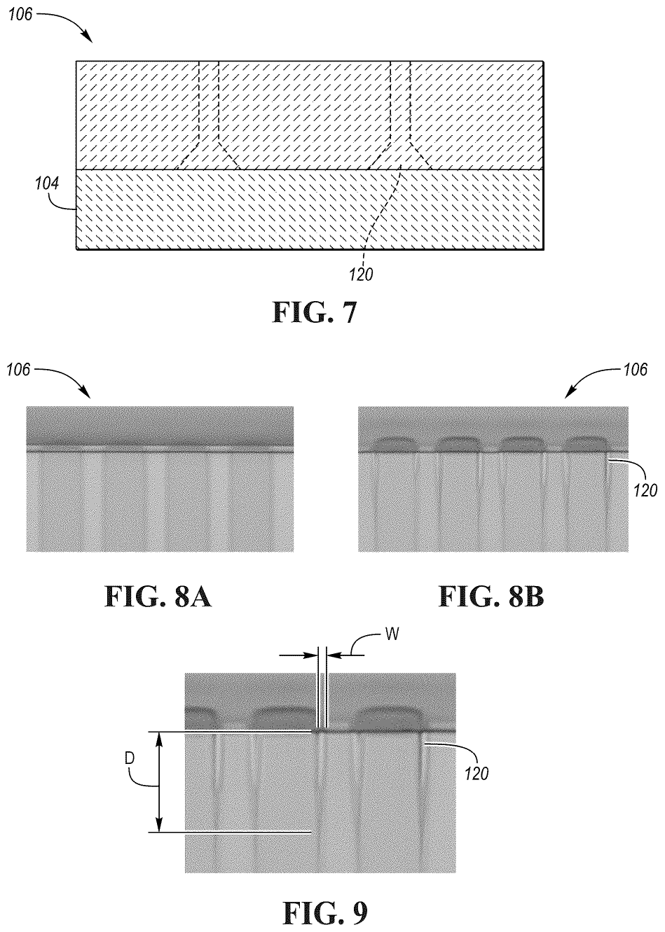

After the capping layer 116 is deposited, a protecting layer 117 may be deposited on the capping layer 116. The protecting layer 117 may be the same material as that of the stop layer 108 and/or the structuring layer 109. The protecting layer 117 may also be a different material from that of the stop layer 108 or the structuring layer 109. The molecules of the gas phase etchant may etch the capping layer 116 as well as the sacrificial layer 110. Etching of these materials may reduce the availability of the gas phase etchant to etch the funnel-like inlet structure illustrated in FIG. 7. If these materials are etched, the funnel etching process may proceed at a slower rate and at a reduced level as the etching of the open surface of the capping layer 116 will consume all of the available etchant molecules. The protecting layer 117 prevents the etchant from etching the open faces of the capping layer 116 to preserve the etchant molecules for the funnel etching process.

FIG. 6A illustrates a cross section view of a microchannel etch 118 in the layer stack 106. The microchannel etch 118 may be adjacent to the nanochannel etch 112 in a horizontal direction. The microchannel etch 118 may be formed using an anisotropic process. The microchannel etch 118 may form a microchannel. More than one microchannel may be formed via this process. The microchannels may interface the nanochannels formed by the nanochannel etch 112. FIG. 6B illustrates a view rotated 90° with respect to the cross section view in FIG. 6A. FIG. 6C illustrates a top view of the microchannel etch 118 in the layer stack 106. The microchannel etch 118 may form a microchannel with a length, width, and height from 1 micron to 100 microns.

FIG. 7 illustrates a top view of a funnel-etch 120 in the layer stack 106 according to an embodiment. The gradient and size of the funnel may be guided by the process parameters and duration. The etch step may lead to a widening of the nanochannel toward the microchannel because the etch rate is higher at the entrance of the nanochannel than on the inside of the nanochannel. After fabrication of the nano- and the adjacent microchannels a vapor phase chemical etch step may be added to create a funnel shape in the horizontal axis on the side of the channel. The etching may be performed using xenon difluoride (XeF₂) or hydrogen fluoride (vHF) vapor etching for example. For XeF₂ to etch materials including SiN and SiO₂, an open silicon surface is present in the vicinity of the etched material. The vapor etch process may be an isotropic and selective etch step and may etch the sacrificial layer 110 next to the channel opening, but not the layers on top and underneath. The material next to the channel may be etched, widening the channel opening in the horizontal direction. The etching may start at the opening of the nanochannel toward the microchannel. The etch rate may be faster at the opening of the buried nanochannel toward the larger microchannel than it is on the inside, due to a better availability and exchange of etchant molecules. This effect may create the funnel-shape. The shape of the resulting funnel may be guided by the parameters and duration of the etch step.

FIG. 8A illustrates a microscope image of a layer stack 106 before the funnel etch step. FIG. 8B illustrates a microscope image of a layer stack 106 after etching the funnel etch 120. The funnel etch 120 was etched with XeF₂. (300 s, 50 sccm N2 through bubbler, 2 Torr), on a layerstack with SiN as the capping layer and AlOx as the protection layer on top of the capping layer.

### EXAMPLES

### Example 1: Testing the Effects of Varying Etching Time, Pressure, and Gas Flow Through the Bubbler on the Width and Depth of the Funnel Etch

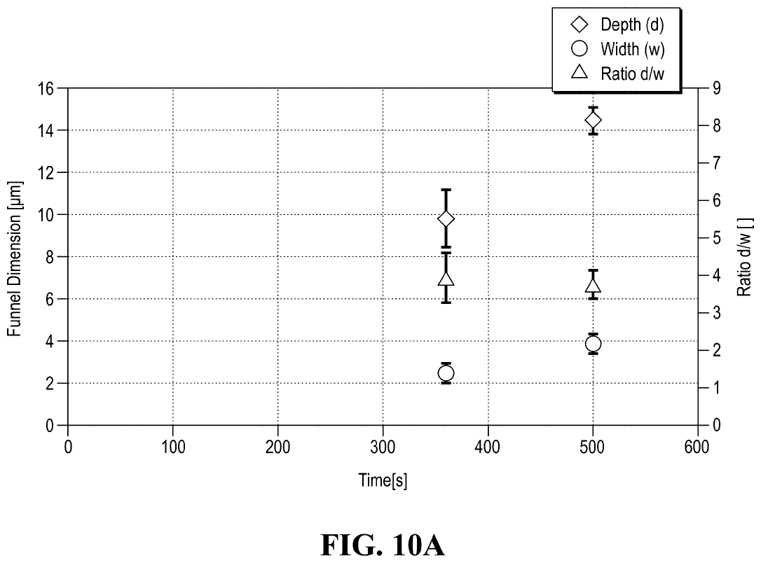

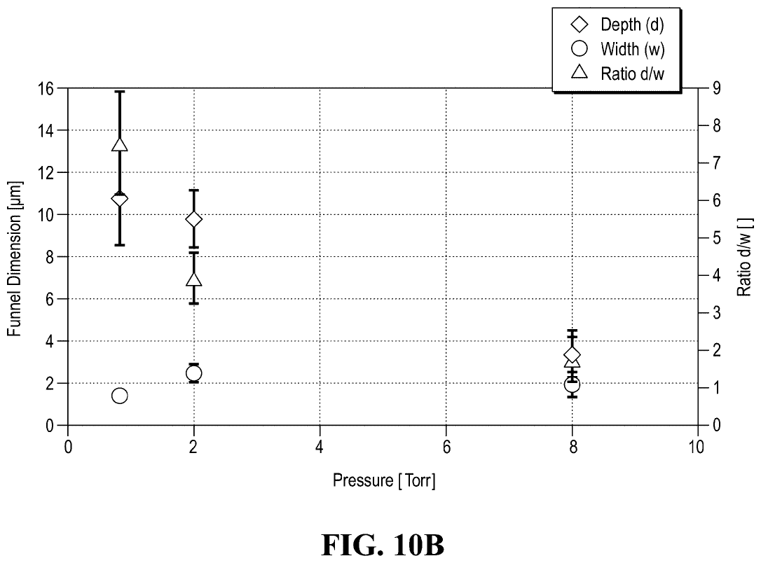

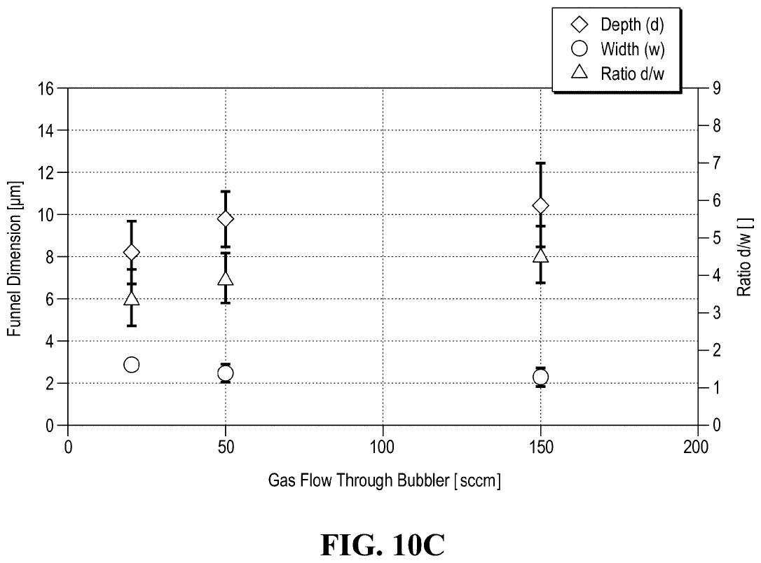

FIG. 9 illustrates a microscope image of a layer stack with the width and depth of the funnel etch labeled. The processing parameters chosen during etching may affect the width and depth of the funnel etch as described in FIGS. 10A through 10C.

FIG. 10A illustrates the effect of etching time on the width and depth of the funnel etch. The time of the etch was varied while the pressure was kept constant at 2 Torr and the gas flow through the bubbler was kept constant at 50 sccm gas flow through an XeF₂ bubbler. FIG. 10B illustrates the effect of pressure on the width and depth of the funnel etch. The time and gas flow were kept constant at 360 s and 50 sccm gas flow through an XeF₂ bubbler. FIG. 10C illustrates the effect of gas flow on the width and depth of the funnel etch. Time and pressure were kept constant at 360 s and 2 Torr.

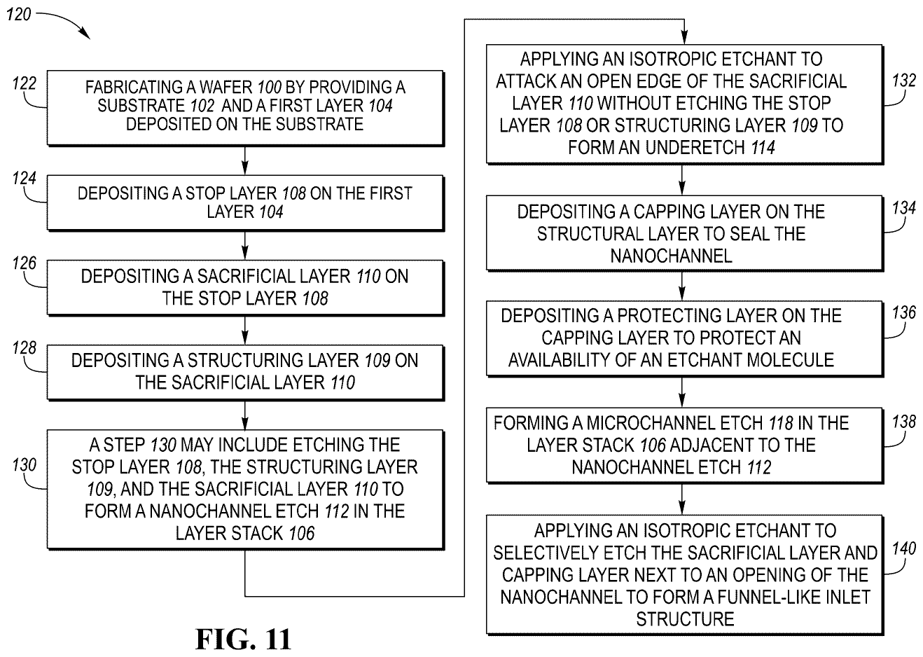

FIG. 11 illustrates a method for fabricating a nanochannel with a funnel-like inlet structure in front of the nanochannel according to an embodiment. The method may include a step 122 of fabricating a wafer 100 by providing a substrate 102 and a first layer 104 deposited on the substrate. The method may additionally include an optional step 124 of depositing a stop layer 108 on the first layer 104. A step 126 may include depositing a sacrificial layer 110 on the stop layer 108. A step 128 may include depositing a structuring layer 109 on the sacrificial layer 110. A step 130 may include etching the stop layer 108, the structuring layer 109, and the sacrificial layer 110 to form a nanochannel etch 112 in the layer stack 106. A step 132 may include applying an isotropic etchant to attack an open edge of the sacrificial layer 110 without etching the stop layer 108 or structuring layer 109 to form an underetch 114. A step 134 may then include depositing a capping layer 116 on the structural layer 109 to cap or seal the nanochannel. The method may also include a step 136 of depositing a protecting layer 117 on the capping layer 116 to protect an availability of an etchant molecule. A step 138 may include forming a microchannel etch 118 in the layer stack 106 adjacent to the nanochannel etch 112. A step 140 may include applying an isotropic etchant to selectively etch the sacrificial layer 110 next to an opening of the nanochannel 112 to form a funnel-like inlet structure. The material next to the opening of the nanochannel may be etched, widening the opening of the nanochannel in a horizontal direction.

What is claimed is:

1. A method of fabricating a nanochannel including a funnel-like inlet structure comprising:
providing a wafer including a substrate, a first layer deposited on the substrate, a stop layer deposited on the first layer, a sacrificial layer deposited on the stop layer, a structuring layer on the sacrificial layer, and the stop layer, the sacrificial layer, and the structuring layer comprising a layer stack defining a nanochannel etch;
applying an isotropic etchant to attack an open edge of the sacrificial layer without etching the stop or structuring layers to form an underetch;
depositing a capping layer on the structural layer to seal the nanochannel;
depositing a protecting layer on the capping layer to protect an availability of an etchant molecule;
forming a microchannel etch in the layer stack adjacent to the nanochannel etch; and
applying an isotropic etchant to selectively etch the sacrificial layer and capping layer next to an opening of the nanochannel to form a funnel-like inlet structure.

2. The method of claim 1, wherein the first layer is SiO₂.

3. The method of claim 1, wherein the stop layer is AlOx.

4. The method of claim 1, wherein the sacrificial layer is SiN.

5. The method of claim 1, wherein the sacrificial layer is SiO₂.

6. The method of claim 1, wherein the capping layer is SiN.

7. The method of claim 1, wherein the stop layer is a different material than the structuring layer.

8. The method of claim 1, wherein the sacrificial layer is deposited by atomic layer deposition.

9. The method of claim 1, wherein the capping layer is deposited by plasma enhanced chemical vapor deposition.

10. The method of claim 1, wherein the funnel-like inlet structure is formed by XeF₂ vapor etching.

11. The method of claim 1, wherein the funnel-like inlet structure is formed by vapor hydrofluoric acid (vHF) etching.

12. The method of claim 1, wherein the nanochannel etch has a width from 10 to nm and a height from 5 to 1000 nm.

13. The method of claim 1, wherein the depth of the nanochannel funnel etch is from 100 nm to 100 μm.

14. A method of fabricating an analytic device for biomolecules comprising:
providing a layer stack including a silicon wafer, a first layer deposited on the silicon wafer, a sacrificial layer deposited on the first layer, and a structuring layer on the sacrificial layer;
forming a nanochannel by:
etching the layer stack to form a nanochannel etch;
etching the sacrificial layer to form an underetch;
depositing a capping layer on the structural layer to seal the nanochannel; and
depositing a protecting layer on the capping layer to protect an availability of an etchant molecule;
forming a microchannel etch in the layer stack adjacent to the nanochannel etch; and
applying an isotropic etchant to selectively etch the sacrificial layer next to an opening of the nanochannel to form a funnel-like inlet structure.

15. The method of claim 14, wherein the layer stack further includes a stop layer deposited on the first layer, wherein the sacrificial layer is deposited on the stop layer.

16. The method of claim 15, wherein the stop layer is AlOx.

17. The method of claim 14, wherein the sacrificial layer is SiN.

18. The method of claim 14, wherein the first layer is SiO₂.

19. The method of claim 14, wherein the sacrificial layer is etched next to an opening of the nanochannel by XeF₂ vapor etching.

20. The method of claim 14, wherein the nanochannel etch has a height from 5 to 1000 nm and a width from 10 to 1000 nm.

21. The method of claim 14, wherein the depth of the nanochannel funnel etch is from 100 nm to 100 μm.

22. The method of claim 14, further comprising forming more than one nanochannel in the layer stack.

23. The method of claim 14, further comprising forming more than one microchannel in the layer stack.

24. A method of fabricating an inlet structure in front of a nanochannel comprising:
providing a wafer including a substrate, a first layer deposited on the substrate, a stop layer deposited on the first layer, a sacrificial layer deposited on the stop layer, a structural layer on the stop layer, and the stop layer, the sacrificial layer, and the structuring layer comprising a layer stack defining a nanochannel etch;
depositing a capping layer on the structural layer to seal the nanochannel;
depositing a protecting layer on the capping layer to protect an availability of an etchant molecule;
forming a microchannel etch in the layer stack adjacent to the nanochannel etch; and
applying an isotropic etchant to selectively etch the sacrificial layer next to an opening of the nanochannel to form a funnel-like inlet structure.
